(19) United States
(12) Patent Application Publication
(10) Pub. No.: US 2008/0079530 A1
(43) Pub. Date: Apr. 3, 2008

(54) INTEGRATED MAGNETIC FEATURES

(76) Inventor: Timothy W. Weidman, Sunnyvale, CA (US)

Correspondence Address: PATTERSON & SHERIDAN, LLP, 3040 POST OAK BOULEVARD, SUITE 1500, HOUSTON, TX, 77056, US

(21) Appl. No.: 11/537,960

(22) Filed: Oct. 2, 2006

(51) Int. Cl. H01F 27/28

(52) U.S. Cl. 336/223

(57) ABSTRACT

The present invention generally relates to the process of forming a magnetic element or magnetic device that may be used to form a component within an integrated circuit device using a combination of electroless plating and various standard semiconductor processing techniques. In one embodiment, a plurality of magnetic devices are formed on a surface of a substrate so that the orientation of features on the surface of the substrate can be ascertained. In one embodiment, the magnetic devices formed on a surface of a substrate are used to physically align a substrate to an external reference having a similar orientation of magnetic elements.

### BACKGROUND OF THE INVENTION

1. Field of the Invention

Embodiments of the present invention generally relate to micromechanical or nano-mechanical devices that require electromagnetic components, and methods of forming the same.

2. Description of the Related Art

Micro-mechanical or nanomechanical magnetic type devices that utilize magnetic materials and coil shaped structures have been discussed in the art, such as a device described in the United State Publication Patent Application No. 20040244488. Common micro-mechanical or nanomechanical devices may be voice coils, electromagnets, sensors (e.g., accelerometers), inductors, or other similar devices. One common component found in these micro-mechanical or nanomechanical devices are magnetic components that are formed on a substrate to provide some driving force to cause some useful motion, detect either motion or position of a component relative to some external reference, and/or allow some information or data to be stored by storage of some form of energy. Current conventional methods used to form such structures are poorly suited to form micron to nanometer scale magnetic components or for incorporating them directly into semiconductor based integrated circuit devices.

Therefore, there is a need for a method to inexpensively form a micro-mechanical or nano-magnetic device which can be implemented within an established integrated circuit fabrication processes.

### SUMMARY OF THE INVENTION

The present invention generally provide an magnetic device formed on a surface of a substrate, comprising a coil assembly formed in a surface of a substrate, wherein the coil assembly comprises a first coil having a conductive region that extends from a first end to a second end, wherein the first coil is formed within a first layer disposed on the surface of the substrate, a second coil having a conductive region that extends from a first end to a second end, wherein the second coil is formed in a second layer disposed over the first layer, and an interconnect feature having a conductive region that is in electrical communication with the first end of the first coil and the first end of the second coil, a magnetic core that has a first end that is in contact with a portion of the first layer and a second end that is in contact with a portion of the second layer and is positioned so that the conductive regions of the first coil and the second coil loop around at least a portion of the length of the magnetic core extending from the first end to the second end, wherein the magnetic core contains a ferromagnetic or ferrimagnetic material that is deposited using an electroless deposition process.

Embodiments of the invention further provide a method of forming an magnetic device on a surface of a substrate, comprising providing a substrate that has a catalytic region exposed on a surface of the substrate, depositing a first dielectric layer on the surface of the substrate, forming a lower planar coil in the first dielectric layer, wherein the lower planar coil has conductive region, a first end and a second end, depositing a second dielectric layer over the first dielectric layer, forming an upper planar coil having a conductive region, a first end that is connected to the first end of the lower planar coil through the second dielectric layer and a second end, wherein the upper planar coil is formed in a second dielectric layer, forming hole through the first and second dielectric layers so that one end of the hole is in communication with the catalytic region and the lower and upper planar coils wind around the hole, and filling the hole with a magnetic material using an electroless deposition process.

Embodiments of the invention further provide a substrate alignment and positioning feature, comprising a first magnetic element positioned on a surface of a substrate, wherein the first magnetic element contains a ferromagnetic or ferrimagnetic material that is disposed within the surface of the substrate, a second magnetic element positioned on the surface of the substrate, wherein the second magnetic element contains a ferromagnetic or ferrimagnetic material that is disposed within the surface of the substrate and the second magnetic element is positioned a distance from the first element in a direction parallel to the surface of the substrate.

Embodiments of the invention further provide a method of aligning two or more substrates, comprising forming an first alignment feature on a surface of a first substrate comprising forming a first magnetic element on a surface of the first substrate using an electroless deposition process, wherein the first magnetic element contains a ferromagnetic material, and forming a second magnetic element on a surface of the first substrate using an electroless deposition process, wherein the second magnetic element contains a ferromagnetic material, forming an first alignment feature on a surface of a second substrate comprising forming a first magnetic element on a surface of the second substrate using an electroless deposition process, wherein the first magnetic element contains a ferromagnetic material, and forming a second magnetic element on a surface of the second substrate using an electroless deposition process, wherein the second magnetic element contains a ferromagnetic material, and aligning the first substrate to the second substrate by positioning the first substrate over the second substrate and allowing the first alignment features in the first and second substrates to align to each other.

Embodiments of the invention further provide a method of aligning a two or more substrates, comprising forming a first magnetic element on a surface of a substrate using an electroless deposition process, wherein the first magnetic element contains a first ferromagnetic material, forming a second magnetic element on a surface of a substrate using an electroless deposition process, wherein the second magnetic element contains a second ferromagnetic material, and positioning a magnetic assembly that has a first magnetic device and a second magnetic device fixedly coupled to each other and is adapted to orient the substrate so that the first magnetic element aligns to the first magnetic device and the second magnetic element aligns to the second magnetic device.

Additional embodiments pertain to other applications of such integrated micro-magnetic elements as sensors, actuators, and for the storage and recall of electronically or magnetically information.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is an isometric cross-sectional view of an electromagnet device formed in accordance with one of the embodiments;

FIG. 1B is a plan view of the electromagnet device that illustrates a top planar coil disposed on the substrate surface in accordance with one of the embodiments;

FIG. 1C is a plan view of the electromagnet device shown in FIG. 1A as viewed from a plane that extends horizontally through a portion of the lower planar coil that is formed in accordance with one of the embodiments;

FIG. 2 is a flow chart depicting a process of forming an electromagnet device as described within an embodiment herein;

FIGS. 3A-3I illustrate schematic cross-sectional views of magnetic device features formed by a process described within an embodiment herein;

FIG. 4 illustrates an isometric view of a substrate having an array of magnetic features formed on a substrate surface that is described within an embodiment herein;

FIG. 5 illustrates an isometric view of a section of a substrate having an array of magnetic features formed on a substrate surface that is described within an embodiment herein;

FIG. 6 illustrates an isometric view of a section of a substrate having an array of magnetic features formed on a substrate surface that is described within an embodiment herein;

FIGS. 7A-7D illustrate schematic cross-sectional views of magnetic features formed by a process described within an embodiment herein;

FIG. 8 is a cross-sectional view of an magnetic feature formed by a process described within an embodiment herein; and

FIG. 9 is a cross-sectional view of two alignment features formed in each of the substrates that are described within an embodiment herein.

### DETAILED DESCRIPTION

The present invention generally relates to the process of forming an magnetic device that may be used to form a component contained within a micro-mechanical or nano-magnetic device, such as a pressure or position sensor, a voice coil, an accelerometer, a micro-mirror, or an optical switch, using various semiconductor processing techniques. Embodiment of the invention may further provide an apparatus and method of orienting and/or physically aligning a substrate to an external reference having a similar orientation of magnetic device elements.

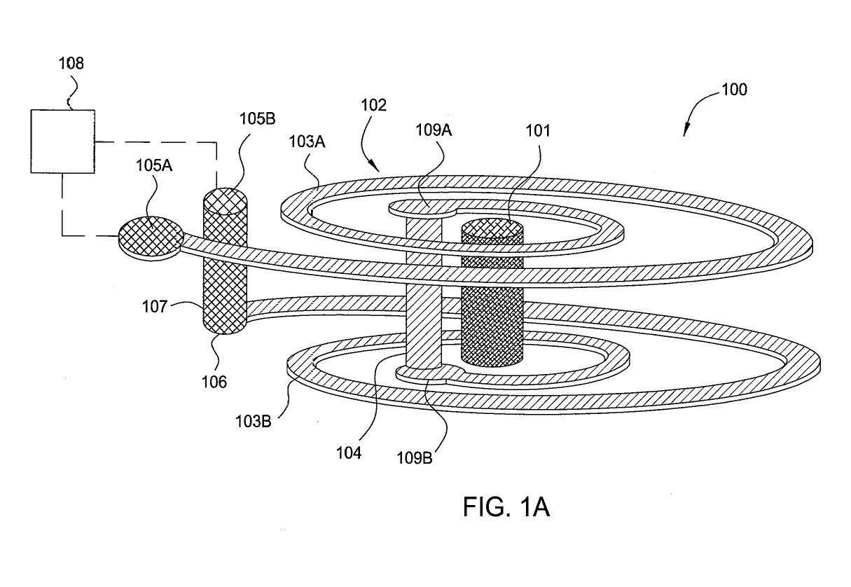

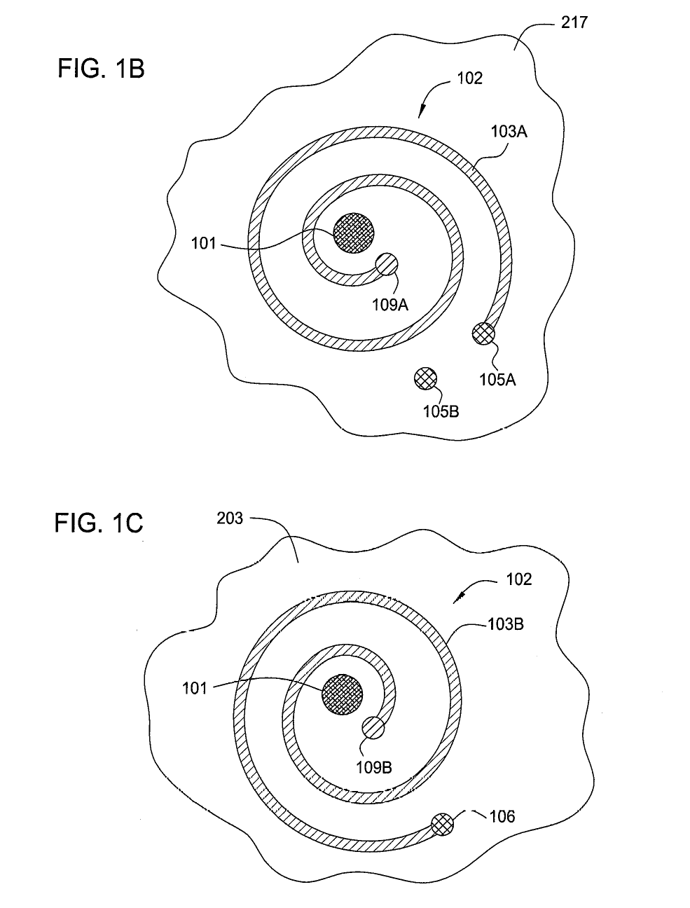

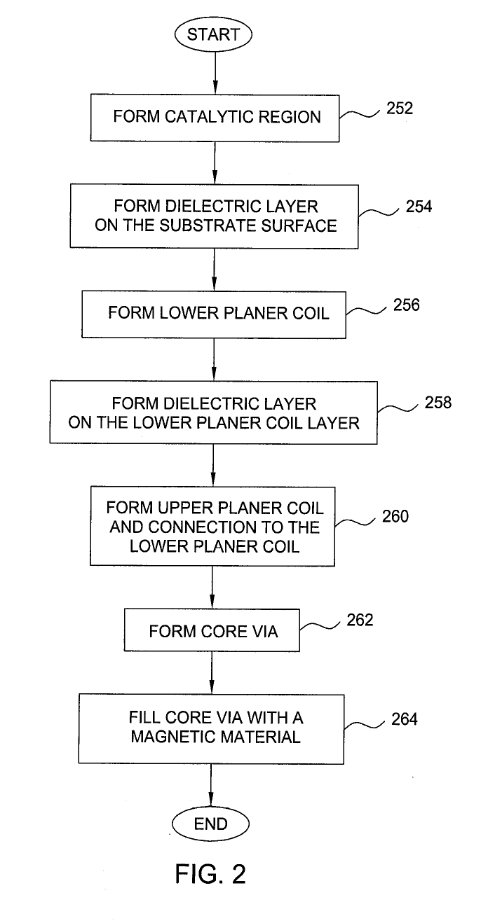

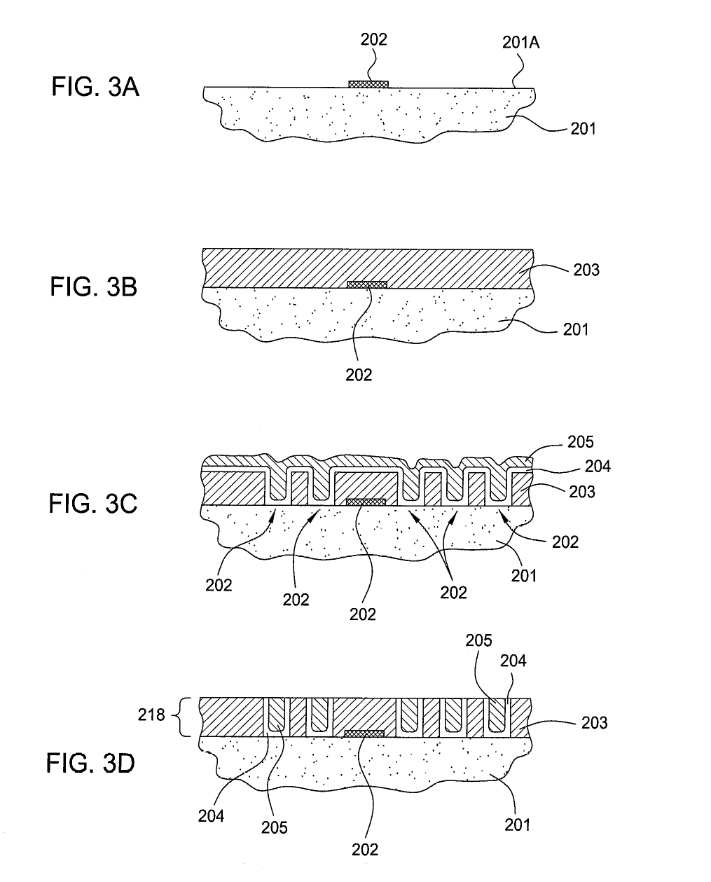

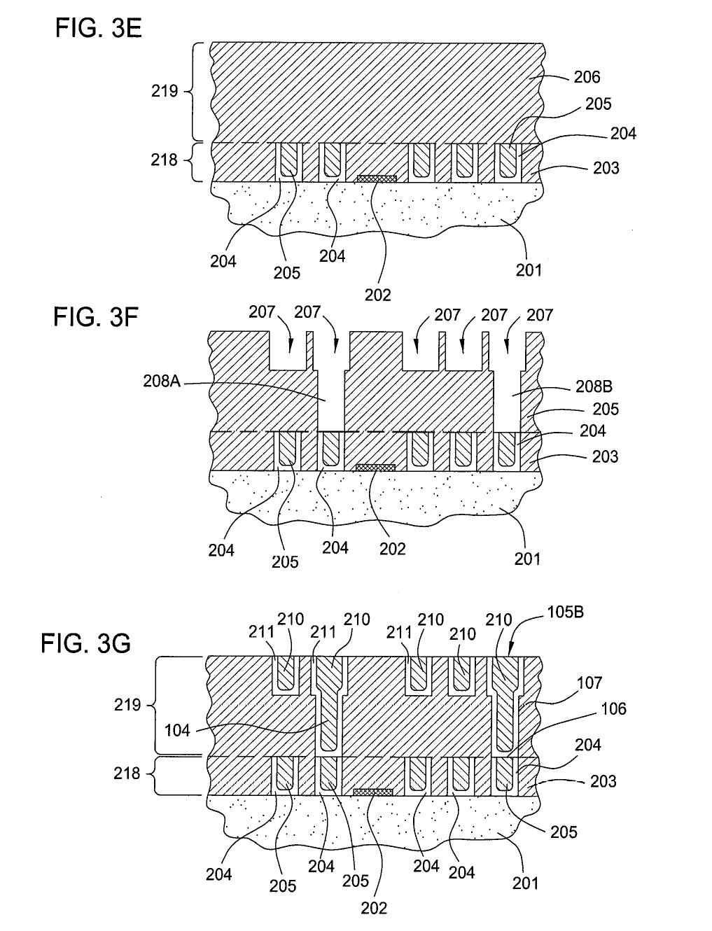

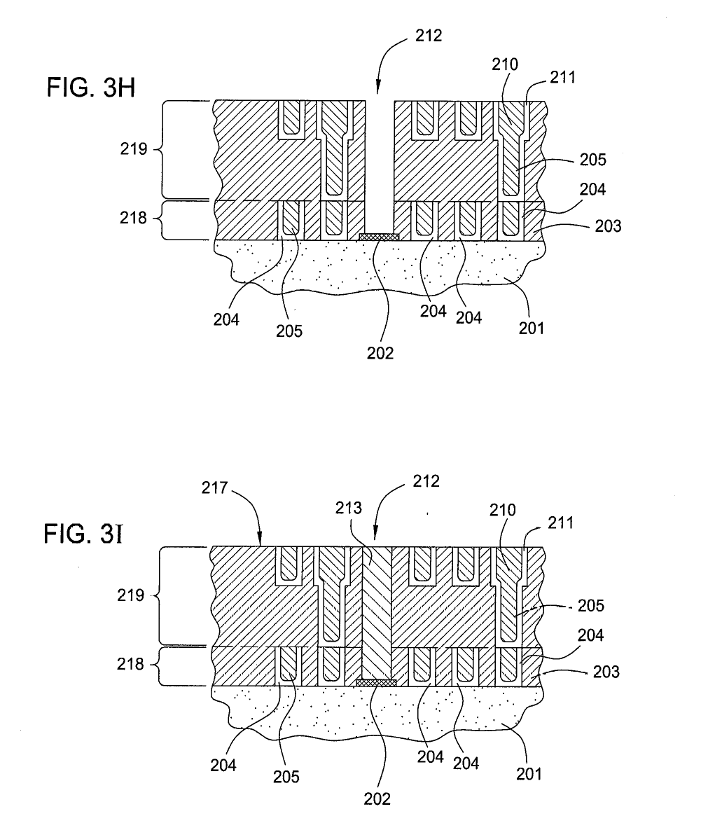

FIG. 1A is an isometric view of one embodiment in which an electromagnet device 100 is formed using a dual damascene type process. The various process steps used to form the electromagnet device 100 are illustrated in FIG. 2 and FIGS. 3A-3I. The electromagnet device 100 generally contains a core 101 and a coil 102 that are formed in a portion of the substrate (e.g., substrate 201 in FIGS. 3A-3I). One will note that the dielectric layer(s) (e.g., dielectric layer 203 and dielectric layer 206 shown in FIGS. 3B-3I) that are used to support and electrically isolate the core 101 and coil 102 components from each other have been removed to clearly show the three dimensional layout of the electromagnet device 100. In one embodiment, the electromagnet device 100 as shown in FIG. 1A, contains two planar coils 103A, 103B that are formed on different levels of the electromagnet device 100 and electrically connected using an interconnect 104.

FIG. 1B is a top view of the electromagnet device 100 that illustrates a top planar coil 103A disposed on the substrate surface 217 (also see FIG. 3I). In this view the top planar coil 103A formed in the dielectric layer 206 is connected to a lower planar coil 103B (see interconnect 104 in FIG. 1A) at one end 109A and then winds around the core 101 where is terminates at the first external connection 105A. The first external connection 105A is generally the first of the two connection points that are used to connect and deliver power to the coil 102 of the electromagnet device 100 from an external power source 108 (see FIG. 1A).

FIG. 1C is a bottom view of the electromagnet device 100 shown in FIG. 1A as viewed from a plane that extends horizontally through a portion of the lower planar coil 103B. FIG. 1C illustrates a lower planar coil 103B formed in the dielectric layer 203 that is connected to the top planar coil 103A (see interconnect 104 in FIG. 1A) at one end 109B and then winds around the core 101 where is terminates at the external connection point 106 that is in contact with the second external connection 105B through the interconnect 107 formed in the dielectric layer 206 (see FIGS. 1A-1B). The second external connection 105B is generally the second of the two connection points that are used to connect the coil 102 to an external power source 108 (see FIG. 1A).

FIG. 2 depicts a process sequence 200 according to one embodiment described herein for fabricating an electromagnet device 100. FIGS. 3A-3I illustrate schematic cross-sectional views of an electromagnet device 100 at different stages of the process sequence 200. Process sequence 200 generally includes the process steps 252-264, that are used to form the electromagnet device 100 using a dual damascene type fabrication process.

In step 252 a catalytic region 202 is deposited on a substrate surface 201A of the substrate 201 by use of a deposition, lithography and etching process sequence (hereafter deposition/lithography process). In one aspect, the catalytic region 202 is deposited by use of a catalytic layer forming ink jet type printing process, which is further described in the U.S. Provisional Patent Application Ser. No. 60/715,024, filed Sep. 8, 2005, which is incorporated herein by reference. One example of a deposition/lithography type process includes, but is not limited to depositing a layer of a catalytic material (not shown) on the substrate surface 201A using a conventional physical vapor deposition technique (PVD) or conventional chemical vapor deposition (CVD) technique, then depositing a resist layer (not shown) on the catalytic layer, then exposing and developing the resist layer using convention lithographic techniques to form a desired pattern on the substrate surface, and then etching the unwanted catalytic material using a wet or dry etch process to form a catalytic region 202 on the substrate surface 201A. FIG. 3A illustrates a cross-sectional view of substrate 201 having the catalytic region 202 formed on the substrate surface 201A. Substrate 201 may comprise a semiconductor material such as, for example, silicon, germanium, silicon germanium, for example. The catalytic region 202 may contain one or more of the following metals, such as nickel (Ni), cobalt (Co), ruthenium (Ru), copper (Cu) rhodium (Rh), iridium (Ir), palladium (Pd), platinum or any combination of the above with each other or other alloying elements.

In one embodiment, rather than forming the catalytic region 202 on the surface of the substrate 201 the catalytic region 202 on which the core 101 is formed is part of an underlying interconnect layer positioned below the layer(s) on which the electromagnet device 100 is formed. In this case, the catalytic region 202 need not protrude above the substrate surface 201A, as shown in FIGS. 3A-3I. In one aspect, the core 101 is a cobalt (Co) material that initiates on a “dummy” or unconnected copper (Cu) pad formed in an underlying interconnect layer positioned below the layer on which the electromagnet device 100 is formed. In yet another embodiment, the catalytic region 202 is formed in the substrate 201 material by use of a conventional implant and masking steps to create a conductive region on which the core 101 can be grown.

Referring now to FIGS. 2 and 3B, in process step 254, a dielectric layer 203 deposited over the catalytic region 202 and the substrate surface 201A using conventional chemical vapor deposition (CVD), plasma enhanced chemical vapor deposition (PECVD), or other similar techniques. The dielectric layer 203 may be an insulating material such as, silicon dioxide, silicon nitride, FSG, and/or carbon-doped silicon oxides, such as SiOₓC_{y}, for example, BLACK DIAMOND™ low-k dielectric, available from Applied Materials, Inc., located in Santa Clara, Calif. In some cases, the dielectric layer 203 may be a semiconducting material such as silicon, germanium, gallium arsenide, or other similar material.

Referring now to FIGS. 2 and 3C, in process step 256, a feature 220 is formed in the dielectric layer 203 and filled using conventional metal deposition techniques to form a part of the lower planar coil 103B. In one aspect, the feature 220 is formed using traditional lithography and dry etching techniques that are well known in the art to form a trench type structure in the dielectric layer 203. After the trench type structure of feature 220 has been formed and any residual lithography materials (e.g., resist) have been removed, the feature 220 is filled with one or more metal layers (e.g., layers 204 and 205 in FIG. 3C) to form the current carrying part of the lower planar coil 103B. In one aspect, as shown in FIG. 3C, the feature 220 is filled with two metal layers in which the first layer is a seed layer 204 and the second layer is a fill layer 205. The seed layer 204 may act as barrier to prevent migration of material contained within the fill layer 205 to other areas of the substrate and/or as a seed on which the fill layer 205 is formed.

The seed layer 204 and/or fill layer 205 may contain one or more of the following metals, such as copper (Cu), aluminum (Al), gold (Au), silver (Ag), nickel (Ni), titanium (Ti), tantalum (Ta), cobalt (Co), molybdenum (Mo), ruthenium (Ru), cobalt (Co), rhodium (Rh), iridium (Ir), palladium (Pd), platinum (Pt), tungsten (W), titanium (Ti), titanium nitride (TiN), tantalum (Ta), tantalum nitride (TaN), or combinations thereof. The seed layer 204 may be deposited using conventional chemical vapor deposition (CVD), atomic layer deposition (ALD), physical vapor deposition (PVD), plasma enhanced chemical vapor deposition (PECVD), or other similar techniques. The fill layer 205 may be deposited using conventional chemical vapor deposition (CVD), atomic layer deposition (ALD), physical vapor deposition (PVD), plasma enhanced chemical vapor deposition (PECVD), electrochemical plating (ECP), electroless plating, or other similar techniques. In one embodiment, a barrier layer (not shown), such as tantalum (Ta), titanium (Ti), tantalum nitride (TaN) or titanium nitride (TiN) is deposited on the dielectric layer 203 before the seed layer 204 and the fill layer 205 are deposited on the substrate surface. The barrier layer (not shown) in this configuration is used to prevent diffusion of the material(s) contained within the seed layer 204 or fill layer 205 into the dielectric layer 203.

Referring to FIG. 3D, in part of the process step 256 the extra material deposited above the feature 220 is removed using conventional chemical mechanical polishing (CMP) or electrochemical mechanical polishing (ECMP) techniques to form a lower planar coil layer 218 in which the lower planar coil 103B is contained (see FIGS. 1A and 1C). In one embodiment, it may be desirable to electrolessly deposit a “capping layer” over the exposed surfaces of the lower planar coil 103B with a cobalt containing alloy to prevent diffusion of the material(s) contained within the seed layer 204 or fill layer 205 into the subsequently deposited dielectric layer 206.

Referring now to FIGS. 2 and 3E, in process step 258, a dielectric layer 206 is deposited over the lower planar coil layer 218 using conventional chemical vapor deposition (CVD), plasma enhanced chemical vapor deposition (PECVD), or other similar techniques. The dielectric layer 206 may be an insulating material such as, silicon dioxide, silicon nitride, FSG, and/or carbon-doped silicon oxides, such as SiOₓC_{y}, for example, BLACK DIAMOND™ low-k dielectric, available from Applied Materials, Inc., located in Santa Clara, Calif. In one embodiment, the dielectric layer 206 is formed using the same dielectric material found in the dielectric layer 203.

Referring now to FIGS. 2 and 3F, in process step 260, a feature 207 is formed in the dielectric layer 206 using conventional lithography and etching techniques to form a part of the top planar coil 103A. In one part of the process one or more vias 208 (i.e., vias 208A and 208B) are formed in the dielectric layer 206 to allow physical and electrical communication between parts of the lower planar coil 103B and the top planar coil 103A or other external devices. In one embodiment, the feature 207 and vias 208 are formed in the dielectric layer 206 using traditional lithography and dry etching techniques that are well known in the art. In one aspect, a via 208A is formed to allow the formation of the interconnect 104, illustrated in FIG. 1A, that connects the lower planar coil 103B to the top planar coil 103A. In one aspect, a via 208B is formed to allow the formation of the interconnect 107, illustrated in FIG. 1A, that connects the lower planar coil 103B to the second external connection 105B. After the feature 207 and vias 208 have been formed any residual lithography and leftover etch materials (e.g., resist) are removed.

Referring now to FIG. 3G, in one embodiment, during the process step 260, the feature 207 and vias 208A and 208B are filled with two metal layers in which the first layer is a seed layer 211 and the second layer is a fill layer 210. The seed layer 211 and/or fill layer 210 may formed using one or more of the following metals, such as copper (Cu), aluminum (Al), gold (Au), silver (Ag), nickel (Ni), titanium (Ti), tantalum (Ta), cobalt (Co), molybdenum (Mo), ruthenium (Ru), cobalt (Co), rhodium (Rh), iridium (Ir), palladium (Pd), platinum (Pt), tungsten (W), titanium (Ti), titanium nitride (TiN), tantalum (Ta), tantalum nitride (TaN), or combinations thereof. The seed layer 211 may be deposited using conventional chemical vapor deposition (CVD), atomic layer deposition (ALD), physical vapor deposition (PVD), plasma enhanced chemical vapor deposition (PECVD), or other similar techniques. The fill layer 210 may be deposited using conventional chemical vapor deposition (CVD), atomic layer deposition (ALD), physical vapor deposition (PVD), plasma enhanced chemical vapor deposition (PECVD), electrochemical plating (ECP), electroless plating, or other similar techniques. In one embodiment, a conventional barrier layer (not shown), such as tantalum (Ta), titanium (Ti), tantalum nitride (TaN) or titanium nitride (TiN) is deposited on the dielectric layer 206 before the seed layer 211 and the fill layer 210 are deposited. The barrier layer is used to prevent diffusion of the metals contained within the seed layer 211 or fill layer 210 into the dielectric layer 206. In one part of the process step 260, all excess material deposited above the feature 207 is removed using conventional chemical mechanical polishing (CMP) and/or electrochemical mechanical polishing (ECMP) techniques to form a upper planar coil layer 219 in which the top planar coil 103A is contained (see FIG. 3G).

Referring now to FIGS. 2 and 3H, in process step 262, a core via 212 is formed using conventional lithographic and etching techniques so that it is formed through dielectric layers 203 and 206 to expose the surface of the catalytic region 202.

Finally, referring to FIGS. 2 and 3I, in process step 264, a core via 212 is filed with a ferromagnetic or ferrimagnetic material or alloy using an electroless deposition process to form the core 101. The core 101 generally contains a metal plug 213 and the catalytic region 202. In process step 264 an electroless deposition process is used to form the metal plug 213 on top of the catalytic region 202. In one aspect, it may be desirable to form the metal plug 213 so that it has a reentrant shape as shown in FIG. 8, which is discussed below. The reentrant shapes may provide mechanical strength to the metal plug 213 to prevent it from being pulled out of the surface of the substrate.

In one embodiment, the metal plug 213 contains a binary alloy or ternary alloy that is ferromagnetic or ferromagnetic. In one embodiment, the metal plug 213 contains a metal such as cobalt (Co), nickel (Ni), or iron (Fe) and/or combinations thereof. In one embodiment, magnetic alloys, such as barium ferrite, strontium ferrite, Alnico, Alumel, Mutamel, Permalloy, Trafoperm, NdFeB, Samarium cobalt alloys (e.g., SmCo₅, Sm₂Co₁₇) may be deposited either by sputtering (physical vapor deposition) or a molecular beam epitaxy (MBE) type process or equivalent to form the metal plug 213. However, since PVD and MBE processes are line-of-sight type deposition processes they are not conducive to the filling of high aspect ratio features. These processes will also require additional steps to remove a large amount of material from other exposed regions of the substrate by use of conventional polishing or etching techniques.

Preferably, the magnetic alloy is selectively grown from the bottom up using an electroless deposition technique. In one embodiment, metal plug 213 may contain cobalt (Co), nickel (Ni), and/or iron (Fe) together with lesser amounts of other elements incorporated during the electroless plating process, such as boron (B) and phosphorus (P). In one example, the metal plug 213 contains a cobalt boride (CoB), cobalt phosphide (coP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), cobalt rhenium phosphide (CoReP), derivatives thereof, or combinations thereof that are electrolessly deposited on the catalytic region 202. It should be noted that even when using an electroless deposition process to form the metal plug 213 a polishing step may need to be performed to remove any excess magnetic alloy material extending above the top of the core via 212 (not shown) prior to performing any subsequent process steps.

### Example of an Electroless Process Used to Fill a Metal Plug 213

The following is an example of a typical electroless process that may be used to fill the core via 212 with a cobalt containing material. Generally, to perform the electroless deposition process the final electroless plating solution that is used to form the metal plug 213 is prepared by mixing a conditioning buffered solution, a metal solution and a buffered reducing agent solution with DI water to form an electroless plating solution that is used to fill the metal plug 213.

In one embodiment, the formed metal plug 213 contains a cobalt boride CoB material. In one example, one part of the conditioning buffered solution, the metal solution and the buffered reducing agent solution are mixed with seven parts of preheated (85° C.) and degassed de-ionized water (e.g., 1:1:1:7 conditioning buffered solution:metal solution:buffered reducing agent solution:DI water). In one example, the conditioning buffered solution contains a buffered cleaning solution includes about 22.3 g/L glycine, about 6.2 g/L boric acid, about 72 g/L citric acid, about 121 g/L diethanolamine (DEA), deionize (DI) water, and an amount of I MAH (25% by weight) sufficient to adjust the pH to about 9.25; the metal solution contains a includes about 74.4 g/L citric acid, about 23.8 g/L cobalt chloride (COCl₂.6H₂O), 0.2 g/L sodium dodecyl sulfate (SDS), deionize (DI) water, and an amount of TMAH (25% by weight) sufficient to adjust the pH to about 9.25; and the buffered reducing agent solution contains about 24 g/L of DMAB, 72 g/L of citric acid, 0.1 g/L of hydroxypyridine, DI water, and then adding 25% TMAH to adjust the pH to about 9.25. As noted above, the component solutions are then added to seven parts of degassed and heated DI water to form a CoB electroless deposition solution. After mixing the final solution it is cooled to a temperature of about 65° C. prior to dispense it on the surface of the substrate. The final electroless solution will directly form a cobalt layer on the surface of a catalytic region 202, such as copper placed at the bottom of the core via 212. An example of an exemplary process of forming an electroless solution and dispensing it on a surface of a substrate is further described in the commonly assigned co-pending U.S. patent application Ser. No. 11/040,962, filed Jan. 22, 2005, which is incorporated be reference herein in it entirety. If the substrate is maintained at a temperature of about 75° C., the average deposition rate is has been measured at about 400 Angstroms/min.

One advantage of the process sequence 200 described above is its ability to be easily integrated within a conventional semiconductor device fabrication process sequence to allow the electromagnet device 100 to be formed along side contact level or interconnect level device features (e.g., MOS device components, vias, trenches). In one example, the lower planar coil 103B is formed during the M1 formation process (steps 254-256), while the top planar coil 103A and interconnect 104 are formed during the M2 level formation process (steps 258-260). In this case, only an additional patterning, lithography and etching steps will likely be required to form the core via 212 and an additional metal deposition step will be required to form the metal plug 213, provided that the catalytic region 202 is formed as part of a conventional metallization step performed on the layer below the M1 layer. If the catalytic region 202 is not formed in a layer below the M1 layer then step 252 will also need to be performed on the substrate surface 201A (FIG. 3A) to form a catalytic region 202 on which the metal plug 213 can be grown.

Referring to FIGS. 1 and 3I, once the electromagnet device 100 is formed the device may be used as an electromagnet by delivering a current to the coil 102. When in use the electromagnet device 100 can be used as part of an actuator, as an electromagnet, or any other similar functioning device. In one embodiment, the coil 102 is used to cause the core 101 to form a permanent magnet. If a generated magnetic field created by flowing a current through the coil 102 are high enough the ferromagnetic material contained within the core 101 will retain some of the magnetism upon removal of the generated magnetic field. In this case the orientation of the north and south poles of the magnetized core 101 can be varied by changing the direction that the current flows through the coil 102 during the process of magnetizing the core 101. This configuration may be useful as a magnetic memory device. It should be noted that the electromagnet device 100 as shown in FIG. 3I may have a plurality of layers deposited over the substrate surface 217 and thus the device and process sequence described herein is not intended to be limiting as to the scope of the invention.

### Alignment Features Using Magnetic Features

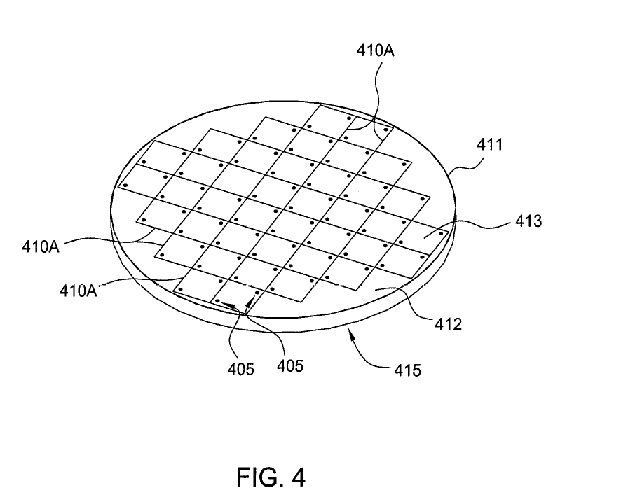

FIG. 4, illustrates one embodiment of the invention in which multiple magnetic elements 405 are positioned within the plurality of chips 413 (e.g., 40 chips 413 are shown) formed on the surface 412 of the substrate 411. As shown the chips 413 are separated by vacant areas, such as scribe lines 410A. In this configuration the magnetic elements 405 are oriented and formed so that the orientation of the devices formed on the chips 413 can be ascertained and/or used to physically align the chip to an external device after the substrate 411 has gone through a “dicing” operation. In general, “dicing” is a process of reducing a substrate 411, or wafer, containing multiple identical integrated circuits (e.g., chips 413) to a plurality of separate and identical chips 413 that contain identical integrated circuits formed thereon. In one embodiment, one or more of the magnetic elements 405 are an electromagnet device 100 that is formed by a processes discussed above. In another embodiment, the magnetic elements 405 are simply a magnetic material (e.g., ferromagnetic, ferrimagnetic) that is deposited on or formed on a surface of the substrate or within a feature formed on a surface of the substrate. For simplicity sake the magnetic elements 405 illustrated in FIGS. 4-8 and discussed below, only Illustrate the latter type of feature.

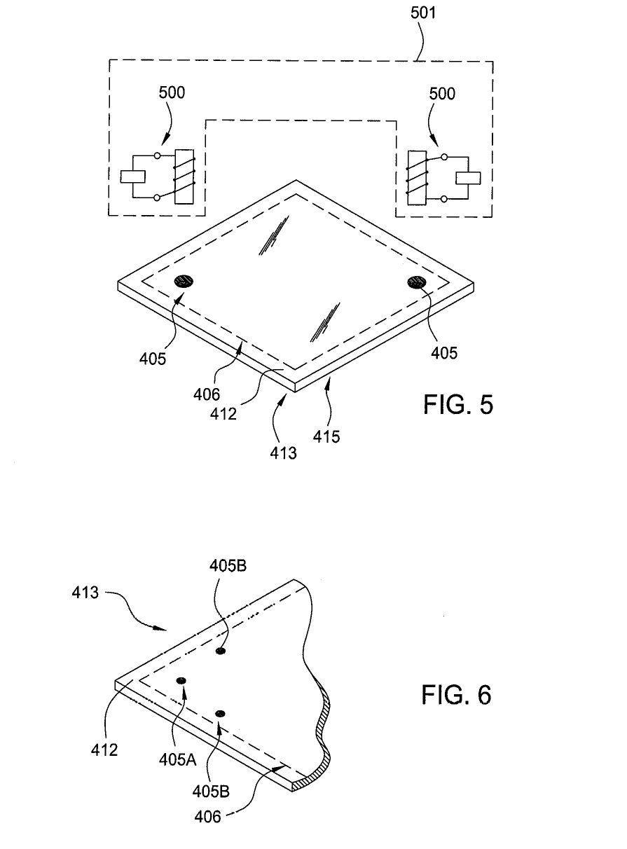

In some packaging applications, such as processes used to form three dimensional memory cards, material is purposely removed from the backside 415 of the substrate 411 until the substrate 411 is relatively thin. In some instances the substrate material is removed until the substrate 411 is between about 50 micrometers and about 100 micrometers thick. In this case the chips 413 formed after dicing the substrate 411 can be very hard to hold, transfer and/or orient due to the fragile nature of the of the very thin chip 413. Therefore, by forming and utilizing the various magnetic elements 405 on the surface of the chips 413 the chip can be transferred, aligned and/or oriented by use of an external magnet device that is attracted to the ferromagnetic parts of the magnetic elements 405 formed on the substrate surface. In one aspect, an array of magnetic elements are placed on the substrate surface to assure that the chips are properly oriented and aligned relative to an external set of aligning magnets (see FIGS. 5 and 6).

FIG. 5 illustrates a chip 413 that has two magnetic elements 405 formed on the surface 412 of the chip 413. In one aspect, the magnetic elements 405 are formed within the “open areas” in between the integrated circuits (not shown) contained within the active area 406 of the chip 413. In one aspect, various magnetic devices 500 contained within a magnetic sensing system 501 are used to sense the position of the chip 413 relative to an external reference frame due to the induced current created when the magnetic elements 405 pass near the magnetic devices 500.

In one embodiment, the magnetic devices 500 contained within the magnetic sensing system 501 are configured to generate a magnetic field that attracts the magnetic elements 405 in the chip 413 to a desired surface (not shown) of the magnetic sensing system 501. Once the magnetic elements 405 on the chip 413 are positioned and aligned to the magnetic devices 500, the chip 413 can be aligned, transferred and positioned as needed.

FIG. 6 illustrates a region of a chip 413 that contains an array of magnetic elements (e.g., 405A-B) formed on a surface of the chip. In this configuration, by use of magnetic elements 405 that act as permanent magnets the orientation of the chip can be repeatably aligned relative to an external reference that has multiple permanent magnets, or electromagnets (e.g., magnetic devices 500), arranged in a similar complementary orientation. In one embodiment, the surface of the chip 413 has a first magnetic element 405A, which is a permanent magnet that has a north pole (N) on the surface of the substrate, and a second magnetic element 405B (e.g., two shown in FIG. 6) which is a permanent magnet that has a south pole (S) on the surface of the substrate. In this configuration the number of allowable orientations that the chip 413 can be aligned relative to a know reference, which contains complementary magnets oriented in a similar fashion, is limited so that each chip 413 can be easily and accurately aligned. This configuration removes need to align the chip 413 using an inaccurate reference such as the external edge or surface of a diced chip 413.

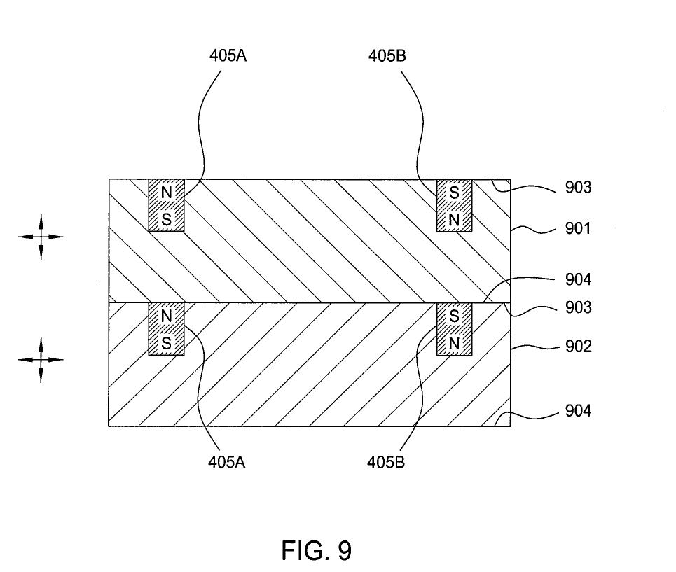

Referring to FIG. 9, in one embodiment the magnetic elements are used to align and/or hold two or more substrate in a desired orientation. FIG. 9 illustrates is a side cross-sectional view of two substrates 901, 902 that each contain two magnetic elements 405A and 405B that are formed in a top surface 903 of each substrate 901, 902. Generally, the magnetic elements 405A and 405B are formed and contain the same materials as the magnetic element 405 described above. In one embodiment, the magnetic element 405B contains a ferromagnetic material that has a magnetic moment oriented so that the north pole (N) is positioned below the south pole (S) and the magnetic element 405A contains a ferromagnetic material that has a magnetic moment oriented so that the north pole (N) is positioned above the south pole (S). In this configuration, when the bottom surface 904 of the first substrate 901 is positioned on the top surface 903 of the second substrate 902 the magnetic elements 405A and 405B contained in each substrate will tend to orient and align themselves in preferred orientation as shown. This configuration will allow multiple fragile substrates, such as two or more three dimensional memory cards to be easily oriented and aligned without human interaction. This configuration may also allow fragile substrates, such as three dimensional memory cards to be easily carried and held. In one embodiment, the substrate 901 is a non-fragile tool that is used to collect and retain a plurality of fragile substrates 902 that may be stacked one on top of the other to allow for easy movement and control of the fragile substrates 902.

It should be noted that it may be advantageous to form the magnetic elements 405A and 405B so that the magnetic moments are both aligned in the same direction (not shown). In this case the substrates 901 and 902 may be aligned in two orientations, such as a magnetic element 405A over a magnetic element 405B and a magnetic element 405B over a magnetic element 405A, or a magnetic element 405A over a magnetic element 405A and a magnetic element 405B over a magnetic element 405B.

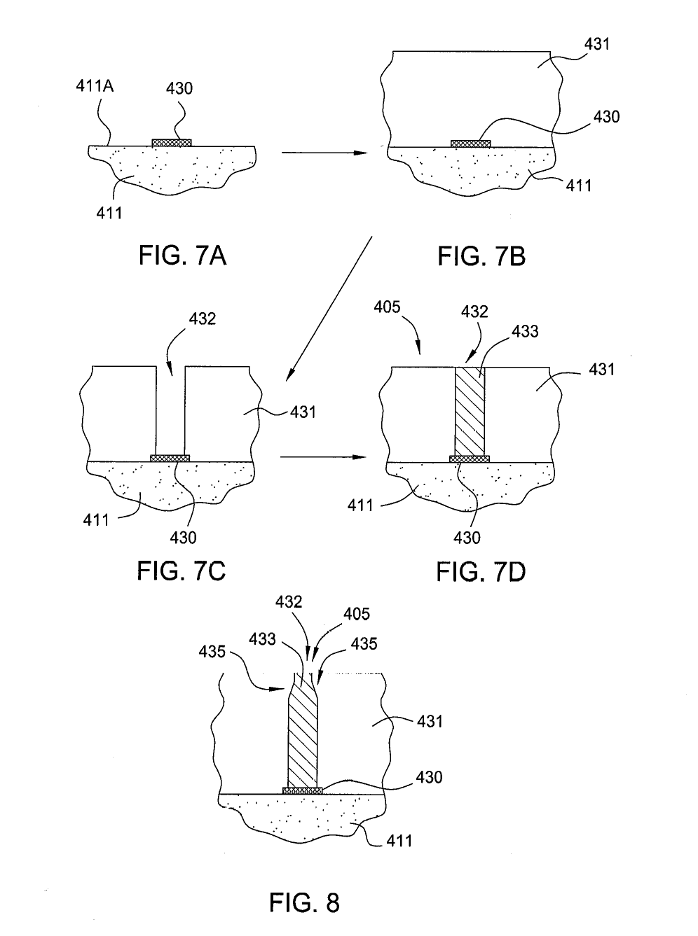

FIGS. 7A-D illustrate schematic cross-sectional views of a process of forming a simple magnetic element 405 that contains a ferromagnetic material. In this configuration, the magnetic element 405 is formed on the surface 411A of the substrate 411 during a chip 413 fabrication processes. In the process of forming the simple magnetic element 405, a magnetic core 433, which contains a ferromagnetic material, is formed by use of an electroless deposition process.

FIG. 7A illustrates a cross-sectional view of substrate 411 that has a catalytic region 430 that has been deposited on the substrate surface 411A by use of a deposition, lithography and etching process sequence (hereafter deposition/lithography process). In one aspect, the catalytic region 430 is deposited by use of a catalytic layer forming ink jet type printing process, which is further described in the U.S. Provisional Patent Application Ser. No. 60/715,024, filed Sep. 8, 2005, which is incorporated by reference.

Referring now to FIG. 7B, in the next step, a dielectric layer 431 is deposited over the catalytic region 430 and the substrate surface 411A using conventional chemical vapor deposition (CVD), plasma enhanced chemical vapor deposition (PECVD), or other similar techniques. The dielectric layer 431 may be an insulating material such as, silicon dioxide, silicon nitride, FSG, and/or carbon-doped silicon oxides, such as SiOₓC_{y}, for example, BLACK DIAMOND™ low-k dielectric, available from Applied Materials, Inc., located in Santa Clara, Calif.

Referring now to FIG. 7C, in the next step, a feature 432 is formed in the dielectric layer 206 using conventional lithography and etching techniques to expose a surface of the catalytic region 430 so that the magnetic core 433 can be electrolessly deposited thereon.

Finally, referring to FIG. 7D, in the last step, a magnetic core 433 containing a ferromagnetic or ferrimagnetic material or alloy is formed using an electroless deposition process. In one aspect, the magnetic core 433 contains a binary alloy or ternary alloy that is ferromagnetic or ferromagnetic. In one embodiment, the magnetic core 433 contains a metal such as iron (Fe), cobalt (Co), nickel (Ni), and/or combinations thereof. In one example, the magnetic core 433 contains a cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), cobalt rhenium phosphide (CoReP), derivatives thereof, or combinations thereof that are electrolessly deposited on the catalytic region 430.

FIG. 8 illustrates a cross-sectional view of a simple magnetic element 405 that contains a feature 432 formed in the dielectric layer 431 that has a reentrant shape 435. The term reentrant shape as used herein is intended to describe a shape that has a smaller opening at the top of the feature 432 than the middle and/or bottom of the feature as shown in FIG. 8. Reentrant shapes, which can be easily formed using conventional dry and/or wet etching processes when forming the feature 432, can provide mechanical strength to the magnetic element 405 to prevent it from being pulled out of the surface of the substrate 411 when the magnetic elements 405 are used a features to align and/or hold the chip 413, as described above.

While the foregoing is directed to embodiments of the present invention, other and further embodiments of the invention may be devised without departing from the basic scope thereof, and the scope thereof is determined by the claims that follow.

1. A electromagnet device formed on a surface of a substrate, comprising:
a coil assembly formed in a surface of a substrate, wherein the coil assembly comprises:
a first coil having a conductive region that extends from a first end to a second end, wherein the first coil is formed within a first layer disposed on the surface of the substrate;
a second coil having a conductive region that extends from a first end to a second end, wherein the second coil is formed in a second layer disposed over the first layer; and
an interconnect feature having a conductive region that is in electrical communication with the first end of the first coil and the first end of the second coil;
a magnetic core that has a first end that is in contact with a portion of the first layer and a second end that is in contact with a portion of the second layer and is positioned so that the conductive regions of the first coil and the second coil loop around at least a portion of the length of the magnetic core extending from the first end to the second end, wherein the magnetic core contains a ferromagnetic or ferrimagnetic material that is deposited using an electroless deposition process.

2. The electromagnet device of claim 1, wherein the material from which the first layer and the second layer are formed is selected from a group consisting of silicon, silicon dioxide, fluorosilicate glass, carbon-doped silicon oxides, germanium and silicon nitride.

3. The electromagnet device of claim 1, wherein the material from which the conductive region in the first coil and the conductive region in the second coil is formed is selected from a group consisting of copper (Cu), aluminum (Al), gold (Au), silver (Ag), nickel (Ni), titanium (Ti), tantalum (Ta), cobalt (Co), molybdenum (Mo), ruthenium (Ru), cobalt (Co), rhodium (Rh), iridium (Ir), palladium (Pd), platinum (Pt), tungsten (W), titanium (Ti), titanium nitride (TiN), tantalum (Ta), and tantalum nitride (TaN).

4. The electromagnet device of claim 1, wherein the material from which the magnetic core is formed is selected from a group consisting of cobalt (Co), nickel (Ni) and iron (Fe).

5. The electromagnet device of claim 1, wherein the material from which the magnetic core is formed is selected from a group consisting of cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), and cobalt rhenium phosphide (CoReP).

6. A method of forming an electromagnet device on a surface of a substrate, comprising:
providing a substrate that has a catalytic region exposed on a surface of the substrate;
depositing a first dielectric layer on the surface of the substrate;
forming a lower planar coil in the first dielectric layer, wherein the lower planar coil has conductive region, a first end and a second end;
depositing a second dielectric layer over the first dielectric layer;
forming an upper planar coil having a conductive region, a first end that is connected to the first end of the lower planar coil through the second dielectric layer and a second end, wherein the upper planar coil is formed in a second dielectric layer;
forming hole through the first and second dielectric layers so that one end of the hole is in communication with the catalytic region and the lower and upper planar coils wind around the hole; and
filling the hole with a magnetic material using an electroless deposition process.

7. The method of claim 6, wherein the material from which the first dielectric layer and the second dielectric layer are formed is selected from a group consisting of silicon, silicon dioxide, fluorosilicate glass, carbon-doped silicon oxides, germanium and silicon nitride.

8. The method of claim 6, wherein the material from which the conductive region of the first coil and the second coil is formed is selected from a group consisting of copper (Cu), aluminum (Al), gold (Au), silver (Ag), nickel (Ni), titanium (Ti), tantalum (Ta), cobalt (Co), molybdenum (Mo), ruthenium (Ru), cobalt (Co), rhodium (Rh), iridium (Ir), palladium (Pd), platinum (Pt), tungsten (W), titanium (Ti), titanium nitride (TiN), tantalum (Ta), and tantalum nitride (TaN).

9. The method of claim 6, wherein the magnetic material is selected from a group consisting of cobalt (Co), nickel (Ni) and iron (Fe).

10. The method of claim 6, wherein the magnetic material is selected from a group consisting of cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), and cobalt rhenium phosphide (CoReP).

11. A substrate alignment and positioning feature, comprising:
a first magnetic element positioned on a surface of a substrate, wherein the first magnetic element contains a ferromagnetic or ferrimagnetic material that is disposed within the surface of the substrate;
a second magnetic element positioned on the surface of the substrate, wherein the second magnetic element contains a ferromagnetic or ferrimagnetic material that is disposed within the surface of the substrate and the second magnetic element is positioned a distance from the first element in a direction parallel to the surface of the substrate.

12. The substrate alignment and positioning feature of claim 11, wherein the first and second magnetic elements each further comprise:
a coil assembly formed in the surface of the substrate, wherein the coil assembly comprises:
a first coil having a conductive region that extends from a first end to a second end, wherein the first coil is formed within a first layer disposed on the surface of the substrate;
a second coil having a conductive region that extends from a first end to a second end, wherein the second coil is formed in a second layer disposed over the first layer; and
an interconnect feature having a conductive region that is in electrical communication with the first end of the first coil and the third end of the second coil;
a magnetic core that has a first end that is in contact with a portion of the first layer and a second end that is in contact with a portion of the second layer and is positioned so that the conductive regions of the first coil and the second coil loop around at least a portion of the length of the magnetic core extending from the first end to the second end, wherein the magnetic core contains a ferromagnetic or ferrimagnetic material that is deposited using an electroless deposition process.

13. The substrate alignment and positioning feature of claim 11, wherein the material from which the first and second ferromagnetic materials are formed is selected from a group consisting of cobalt (Co), nickel (Ni) and iron (Fe).

14. The substrate alignment and positioning feature of claim 11, wherein the material from which the first and second ferromagnetic materials are formed is selected from a group consisting of cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), and cobalt rhenium phosphide (CoReP).

15. A method of aligning two or more substrates, comprising:
forming an first alignment feature on a surface of a first substrate comprising:
forming a first magnetic element on a surface of the first substrate using an electroless deposition process, wherein the first magnetic element contains a ferromagnetic material; and
forming a second magnetic element on a surface of the first substrate using an electroless deposition process, wherein the second magnetic element contains a ferromagnetic material;
forming an first alignment feature on a surface of a second substrate comprising:
forming a first magnetic element on a surface of the second substrate using an electroless deposition process, wherein the first magnetic element contains a ferromagnetic material; and
forming a second magnetic element on a surface of the second substrate using an electroless deposition process, wherein the second magnetic element contains a ferromagnetic material; and
aligning the first substrate to the second substrate by positioning the first substrate over the second substrate and allowing the first alignment features in the first and second substrates to align to each other.

16. The method of claim 15, wherein the material from which the first and second magnetic elements in the first alignment features on the first and second substrates are formed is selected from a group consisting of cobalt (Co), nickel (Ni) and iron (Fe).

17. The method of claim 15, wherein the material from which the first and second magnetic elements in the first alignment features on the first and second substrates are formed is selected from a group consisting of cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), and cobalt rhenium phosphide (CoReP).

18. The substrate alignment and positioning feature of claim 15, wherein the first and second magnetic elements in the first and the second substrates each further comprise:
a coil assembly formed in the surface of the substrate, wherein the coil assembly comprises:
a first coil having a conductive region that extends from a first end to a second end, wherein the first coil is formed within a first layer disposed on the surface of the substrate;
a second coil having a conductive region that extends from a first end to a second end, wherein the second coil is formed in a second layer disposed over the first layer; and
an interconnect feature having a conductive region that is in electrical communication with the first end of the first coil and the third end of the second coil;
a magnetic core that has a first end that is in contact with a portion of the first layer and a second end that is in contact with a portion of the second layer and is positioned so that the conductive regions of the first coil and the second coil loop around at least a portion of the length of the magnetic core extending from the first end to the second end, wherein the magnetic core contains a ferromagnetic or ferrimagnetic material that is deposited using an electroless deposition process.

19. A method of aligning a two or more substrates, comprising:
forming a first magnetic element on a surface of a substrate using an electroless deposition process, wherein the first magnetic element contains a first ferromagnetic material;
forming a second magnetic element on a surface of a substrate using an electroless deposition process, wherein the second magnetic element contains a second ferromagnetic material; and
positioning a magnetic assembly that has a first magnetic device and a second magnetic device fixedly coupled to each other and is adapted to orient the substrate so that the first magnetic element aligns to the first magnetic device and the second magnetic element aligns to the second magnetic device.

20. The method of claim 19, wherein the material from which the first and second magnetic elements are formed is selected from a group consisting of cobalt (Co), nickel (Ni) and iron (Fe).

21. The method of claim 19, wherein the material from which the first and second magnetic elements are formed is selected from a group consisting of cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum boride (NiMoB), nickel molybdenum phosphide (NiMoP), nickel rhenium phosphide (NiReP), nickel rhenium boride (NiReB), cobalt rhenium boride (CoReB), and cobalt rhenium phosphide (CoReP).
